(19) United States
(12) Patent Application Publication
(10) Pub. No.: US 2024/0006121 A1
(43) Pub. Date: Jan. 4, 2024

(54) INTEGRATED CO-FIRED INDUCTOR AND PREPARATION METHOD THEREFOR

(71) Applicant: HENGDIAN GROUP DMEGC MAGNETICS CO., LTD, Jinhua (CN)

(72) Inventors: Xianghua Han, Jinhua (CN); Zhihong Jin, Jinhua (CN); Cong Zhang, Jinhua (CN); Jun Xu, Jinhua (CN); Linke Wang, Jinhua (CN); Ning Zhang, Jinhua (CN)

(73) Assignee: HENGDIAN GROUP DMEGC MAGNETICS CO., LTD, Jinhua (CN)

(21) Appl. No.: 18/255,537

(22) PCT Filed: Oct. 12, 2021
(86) PCT No.: PCT/CN2021/123156

§ 371 Date: Jun. 1, 2023

(30) Foreign Application Priority Data
Dec. 4, 2020 (CN) 202011410893.9
Dec. 4, 2020 (CN) 202022897632.6

(51) Int. Cl. H01F 41/02; H01F 41/00; H01F 27/28; H01F 1/24

(52) U.S. Cl. CPC H01F 41/0246; H01F 1/24; H01F 27/2823; H01F 41/005

(57) ABSTRACT

An integrated co-fired inductor and preparation method therefor, comprising: filling a mold cavity with a magnetic powder, embedding at least one wire in the magnetic powder, wherein the two ends extend out of the mold cavity, sequentially performing compression molding and heat treatment to obtain a magnetic core, and bending and tinning the wire extending out of the magnetic core to obtain the co-fired inductor. The preparation method uses an integrated mold forming process to prepare the inductor to avoid an assembly process involving an excessive number of components; heat treatment is performed after the integral forming process, stress is fully released, material hysteresis loss is reduced, and the loss of the device under light load conditions is reduced; no extra gap exists between the wire and the magnetic core, air gaps are uniformly distributed within the magnetic core, and the vibration noise of eddy current loss is reduced.

### CROSS-REFERENCE TO RELATED APPLICATIONS

This is a national stage application filed under 37 U.S.C. 371 based on International Patent Application No. PCT/CN2021/123156, filed Oct. 12, 2021, which claims priority to Chinese Patent Application No. 202011410893.9, filed on Dec. 4, 2020 and Chinese Patent Application No. 202022897632.6, filed on Dec. 4, 2020, the disclosures of which are incorporated herein by reference in their entireties.

### TECHNICAL FIELD

The present application belongs to the technical field of inductor manufacturing, and relates to an integrated co-fired inductor and a preparation method therefor.

### BACKGROUND

In recent years, with the widespread use of mobile equipment, home appliances, automobiles, industrial equipment, data center servers, communication base station servers and other equipment, energy consumption has become a key consideration. With the continuous development of components towards miniaturization, multi-function, high performance and power saving, the mounted electronic components are required to be miniaturization/thinning and have high performance Improving the efficiency in DC-DC converter and reducing the heat generation are the key conditions for the miniaturization of electronic components. In particular, with the high-speed conversion of the DC-DC converter IC and the further development of the low impedance of the used inductor, the core power supply circuit is also increasingly required to be miniaturization/thinning, low direct current impedance, corresponding high current, and high reliability.

It has gradually become the mainstream to apply the third-generation semiconductor to power devices at present, and especially, the gallium nitride (GaN) and silicon carbide (SiC) technology has been relatively mature, which is suitable for manufacturing high-frequency high-power devices with high temperature, high voltage, and high current resistance. Among them, the power semiconductor is its main application field. Gallium nitride is currently a strong competitor in mobile communications with its outstanding advantages in high-frequency circuit. At present, the main application scenarios are mainly focused on the base station power amplifier, aerospace and other military fields, while also gradually moving towards the field of consumer electronics. Benefiting from the high output power and high energy efficiency characteristics, it is able to achieve a smaller volume in a given power level and thus can be applied in the fast-charging products. The physical properties of silicon carbide materials are superior to those of silicon and the like. The forbidden band width of the silicon carbide single crystal is about 3 times of that of the silicon material, the thermal conductivity is 3.3 time of that of the silicon material, the electron saturation velocity is 2.5 times of that of the silicon, and the breakdown field strength is 5 times of that of the silicon, which has irreplaceable advantages in high-temperature, high-pressure, high-frequency and high-power electronic devices. With the successful application of silicon carbide power semiconductors in high-end car markets such as Tesla, the automotive sector will be the main driving force for the growth of silicon carbide in the future.

Power semiconductor is the core of power conversion and circuit control in electronic devices, and it is also the core component to achieve the voltage, frequency, DC/AC conversion in electronic devices. Power IC, IGBT, MOSFET, diode are the four most widely used power semiconductor products. Electronic components such as inductors and capacitors that work in coordination with power semiconductors to improve the efficiency of power conversion also need to meet the development trend of the third-generation semiconductor. The high-frequency, high-current, high-saturation current, high-reliability inductor is also a necessary part of high energy efficiency power supply.

For the traditional high-current-resistant inductor, the soft magnetic material is prepared into a discrete component, then coil is wound around the magnetic core, and the air gap is arranged to realize high saturation current superposition of the inductor. Due to the need to open the air gap and the need of the structure, the size of this type of inductor is often large, and especially the thickness dimension is often more than 3 mm or even up to 7 mm. This is resulted from the characteristics of soft magnetic ferrite material itself that although the magnetic permeability is high, it is easy to be saturated under external field due to its low saturation magnetic induction intensity. In order to improve the saturation current capacity, the air gap needs to be opened to reduce the effective magnetic permeability. The added air gap increases the size of the device and at the same time requires assembly and tolerance matching on the manufacturing process, which has a certain impact on the yield of the product production.

The metal magnetic powder core material has developed rapidly in recent years due to its characteristics of high saturation magnetic induction intensity, high temperature stability, impact resistance and low noise. Especially in the field of integrated inductor, the application of FeSiCr, carbonyl iron, iron-nickel and other metal soft magnetic materials has made rapid progress. The integrally for inductor adopts a metal soft magnetic material, and that coil is arrange in the metal powder core and then molded integrally.

CN205230770U discloses a vertical thin high-current inductor, which includes an upper magnetic core, a lower magnetic core and an inductor coil arranged between the upper magnetic core and the lower magnetic core, wherein after the inductor coil is formed by winding a flat metal copper wire, upper and lower extended flat pins are bent into 90 degrees, directions of the two flat pins are opposite, the upper magnetic core is a square body, the lower magnetic core is provided with a groove for accommodating the inductor coil, and a positioning post for fixing the inductor coil is arranged at the middle part of the groove. Such inductance element needs to use varnished wire of the coil due to the winding, the molding pressure should not be large, and otherwise, an insulating layer of the coil is easily damaged to cause an interlayer short circuit. Secondly, the stress brought by the forming pressure makes the magnetic core material produce stress anisotropy, thus increasing the hysteresis loss of the material. In view of these facts, the DUI type inductance product has also been developed, that is, the metal powder core is prepared into U sheet and I sheet, and after the magnetic powder cores are sintered, the flat copper wire is clamped in the middle and assembled into the inductor.

CN110718359A discloses a manufacturing structure of a surface mounting integrated inductor and a method thereof. A mixture of a magnetic powder and a thermosetting resin is pre-molded into two identical pressing bodies. The pressing bodies have pressing surfaces, and the pressing surface is high on two sides and low in the middle. In the forming mold, two pressing bodies are respectively placed just above and just below the built-in coil, the pressing surfaces of the pressing bodies need to face the built-in coil, two ends of the built-in coil need to respectively exceed the ranges of two ends of the pressing bodies, and the two pressing bodies and the built-in coil are integrally molded into a blank body by pressurizing or heating. The two ends of the built-in coil after molding are exposed outside the blank body and form external electrodes at two ends of the blank body.

However, such method, in which the inductor is manufactured by assembling several components together, is prone to introducing additional air gap between the magnetic coil and the core, thereby reducing the effective magnetic permeability. Moreover, because some components need to be made into a sheet, the molding precision of the product is not enough, and polishing processing is needed, which increases the process cost and reduces the product yield.

### SUMMARY

The following is a summary of the subject detailed herein. This summary is not intended to limit the scope of the claims.

Aiming at the defects of the prior art, the present application is to provide an integrated co-fired inductor and a preparation method therefor. The preparation method provided by the present application adopts an integrated molding process to prepare the inductor, avoiding the assembly processes of too many components; the heat treatment performed after the integrated molding fully releases stress and reduces the hysteresis losses of materials; the device losses are reduced at the underloading operating conditions; no extra gap exists between the wire and the magnetic core, and air gaps are uniformly distributed in the magnetic core, reducing the vibration noise of eddy current losses.

To achieve the object, the present application adopts the following technical solutions.

In a first aspect, the present application provides a preparation method for an integrated co-fired inductor, and the preparation method includes:
filling a mold cavity with a magnetic powder, embedding at least one wire into the magnetic powder, in which two ends of the wire extend out of the mold cavity, then performing compression molding and heat treatment in sequence to obtain a magnetic core, and bending and tin-attaching the wire extending out of the magnetic core to obtain the co-fired inductor.

The preparation method provided by the present application adopts an integrated molding process to prepare the inductor, avoiding the assembly processes of too many components; the heat treatment performed after the integrated molding fully releases stress and reduces the hysteresis losses of materials; the device losses are reduced at the underloading operating conditions; no extra gap exists between the wire and the magnetic core, and air gaps are uniformly distributed in the magnetic core, reducing the vibration noise of eddy current losses.

As a preferred technical solution of the present application, the wire is a bare wire without paint layer.

Preferably, the wire is a copper wire.

Preferably, the wire is a flat wire having a rectangular cross section.

Preferably, the wire is a straight wire or a special-shaped wire.

Preferably, a shape of the special-shaped wire includes an S-shape, an L-shape, a U-shape, a W-shape or an E-shape.

Preferably, the wires are laid inside the magnetic powder side by side at intervals on a horizontal plane.

The inductor designed by the present application requires low direct current resistance, and the copper wire is to be subjected to high-temperature heat treatment together with the metal soft magnetic material. The flat copper wire without paint layer is capable of high-temperature heat treatment, further reducing the powder core losses. The shape of the copper wire can be designed according to needs, including an I-shape, an S-shape, an L-shape, a U-shape, a W-shape, an E-shape, etc. The workpieces can be molded one by one, or molded by multi-row compression molding via being fixed with a wire frame.

As a preferred technical solution of the present application, the compression molding is performed in a manner of hot pressing or cold pressing.

According to the characteristics of the pelletized powder and the requirements of inductance, the hot pressing molding method can be adopted. For the hot pressing molding, the required pressure is smaller; the magnetic core and the wire can be in closer contact after the hot pressing molding and the required pressure is smaller; however, the hot pressing will reduce the pressing efficiency.

Preferably, the hot pressing is performed at more than or equal to 800 MPa/cm², such as 800 MPa/cm², 810 MPa/cm², 820 MPa/cm², 830 MPa/cm², 840 MPa/cm², 850 MPa/cm², 860 MPa/cm², 870 MPa/cm², 880 MPa/cm², 890 MPa/cm² or 900 MPa/cm²; however, the pressure is not limited to the listed values, and other unlisted values within the numerical range are also applicable; the pressure is further preferably 2000 MPa/cm².

In the present application, since there is no limitation of the paint layer, the molding pressure of the magnetic powder can be used to obtain the magnetic core with higher density. Preferably, the pressure is more than 800 MPa/cm² and even can reach 2000 MPa/cm². The optimum pressure suitable for the inductor is selected according to the serve life of the mold and the press capability.

Preferably, the hot pressing is performed at 90-180° C., such as 90° C., 100° C., 110° C., 120° C., 130° C., 140° C., 150° C., 160° C., 170° C. or 180° C.; however, the temperature is not limited to the listed values, and other unlisted values within the numerical range are also applicable.

Preferably, the hot pressing is performed for 5-100 s, such as 5 s, 10 s, 20 s, 30 s, 40 s, 50 s, 60 s, 70 s, 80 s, 90 s or 100 s; however, the time is not limited to the listed values, and other unlisted values within the numerical range are also applicable.

Preferably, the heat treatment is an annealing treatment.

Preferably, the heat treatment is performed under a protective atmosphere.

Preferably, the protective atmosphere uses nitrogen and/or an inert gas.

Preferably, the heat treatment is performed at 650-850° C., such as 650° C., 660° C., 670° C., 680° C., 690° C., 700° C., 710° C., 720° C., 730° C., 740° C., 750° C., 760° C., 770° C., 780° C., 790° C., 800° C., 910° C., 920° C., 930° C., 940° C. or 950° C.; however, the temperature is not limited to the listed values, and other unlisted values within the numerical range are also applicable.

Preferably, the heat treatment is performed for 30-50 min, such as 30 min, 32 min, 34 min, 36 min, 38 min, 40 min, 42 min, 44 min, 46 min, 48 min or 50 min; however, the time is not limited to the listed values, and other unlisted values within the numerical range are also applicable.

In the present application, the pressed green body inductor is subjected to heat treatment to densify the magnetic core, in order to obtain higher saturation magnetic induction intensity, higher magnetic permeability and lower losses as well as improved strength of the inductor device. Different heat treatment temperatures are selected based on different materials. For example, for amorphous metal soft magnetic powder such as FeSiB, FeSiBCr and FeNiSiBPC, the heat treatment temperature cannot exceed the crystallization temperature of the powder; for the nanocrystalline soft magnetic alloy powder, the heat treatment temperature should be higher than the crystallization temperature but lower than the grain growth temperature, and the specific heat treatment temperature is determined based on the curve obtained from a differential scanning calorimeter and then the heat treatment process is set; for the soft magnetic powder such as FeSiAl, FeNi, FeNiMo and FeSi which are atomized by gas or water, or atomized by water-gas combination, or atomized through multiple stages, the high-temperature heat treatment should be selected according to the powder combination, and the heat treatment temperature is higher than 650° C. but lower than 850° C. The heat treatment may be performed under the protection of an inert gas such as nitrogen or argon, or under the protection of a reducing gas such as hydrogen or a mixture of hydrogen and nitrogen. Since the wire used in the present application has no paint layer and the shape of the wire is an I-shape, an S-shape, an L-shape, a U-shape, a W-shape, an E-shape, etc., the wires are insulated from touching each other, and the short circuit problem between the wires is avoided.

As a preferred technical solution of the present application, the preparation method further includes: impregnating and spray-coating the magnetic core in sequence before the bending and tin-attaching.

Preferably, the impregnating is vacuum impregnation.

Preferably, a spray-coating liquid used for the spray-coating includes an epoxy resin, a paint or Parylene.

In the present application, the heat-treated inductance element is impregnated and spray-coated to further improve the strength, corrosion resistance and reliability of the inductance element. During the impregnation and spray-coating, the exposed wire outside the magnetic core needs to be protected to prevent the impregnation and spray-coating from insulating the wire. The impregnation can adopt vacuum impregnation or common impregnation, which has no influence on the inductance characteristic of the inductor. The spray-coating can adopt the epoxy resin, paint, Parylene and other common spray-coating systems. For some specific soft magnetic powder materials with good corrosion resistance, the wire-bending and tin-attaching can be directly performed without the impregnation step.

As a preferred technical solution of the present application, the magnetic powder is prepared by the following method: subjecting a soft magnetic powder to insulation coating, secondary coating and pelletizing treatment in sequence to obtain the magnetic powder.

Preferably, the soft magnetic powder is obtained by combining powders with two different particle sizes, wherein the powder with a larger particle size has a D50 of 6-50 μm, such as 6 μm, 10 μm, 15 μm, 20 μm, 25 μm, 30 μm, 35 μm, 40 μm, 45 μm or 50 μm; the powder with a smaller particle size has a D50 of 1-6 μm, such as 1 μm, 2 μm, 3 μm, 4 μm, 5 μm or 6 μm; however, the particle size is not limited to the listed values, and other unlisted values within the numerical range are also applicable.

Preferably, the powder includes FeSiCr, FeSi, FeNi, FeSiAl, a carbonyl iron powder, a carbonyl iron nickel powder, FeNiMo, a Fe-based amorphous nanocrystalline material, a Co-based amorphous nanocrystalline soft magnetic material or a Ni-based amorphous nanocrystalline soft magnetic material.

In the present application, the combination of the soft magnetic powders is mainly optimized and designed based on the magnetic permeability, direct current bias capability and magnetic core loss characteristic to satisfy the needs of inductance characteristics. With controlled particle size, coating and matched combination of the powders, magnetic rings are pressing-molded to evaluate the magnetic permeability, direct current bias capability and magnetic core loss characteristic of the combined magnetic powder, and the appropriate combination system is selected according to the design. As a preferred solution, the coarse powder and the fine powder are generally mixed and matched. The powder can be of sphere, ellipsoid or droplet morphology. As a preferred solution, the soft magnetic powder can be prepared by an atomization process including a gas atomization, a water atomization and a water-gas combination atomization; the carbonyl iron powder and carbonyl iron nickel powder are prepared by thermal decomposition of compounds with carbonyl group as well as iron or iron nickel, such as Fe(CO)₅, or (FeNi)(CO)ₓ. The fine powder refers to the powder with a D50 of 1-6 μm measured by laser particle size analyzer, and the coarse powder refers to the powder with a D50 of 6-50 μm measured by laser particle size analyzer. Through the powder combination, the molding density of the soft magnetic composite material can be improved, and the saturation magnetic induction intensity, direct current bias characteristic and loss characteristic can be adjusted.

As a preferred technical solution of the present application, a coating process used for the insulation coating includes phosphating, acidification, oxidation or nitridation, and further preferably, the soft magnetic powder is subjected to insulation coating by phosphating.

Preferably, the phosphating includes: mixing and stirring the soft magnetic powder and a diluted phosphoric acid, and performing drying to obtain a phosphated soft magnetic powder.

Preferably, that phosphoric acid is dilute with acetone.

Preferably, the phosphoric acid and acetone have a mass ratio of 1:(60-70), such as 1:60, 1:61, 1:62, 1:63, 1:64, 1:65, 1:66, 1:67, 1:68, 1:69 or 1:70; however, the mass ratio is not limited to the listed values, and other unlisted values within the numerical range are also applicable.

Preferably, the phosphoric acid and acetone are mixed and stirred for 1-6 min, such as 1 min, 2 min, 3 min, 4 min, 5 min or 6 min; the mixture is allowed to stand for 5-10 min for later use, such as 5 min, 6 min, 7 min, 8 min, 9 min or 10 min; however, the time is not limited to the listed values, and other unlisted values within the numerical range are also applicable.

Preferably, the soft magnetic powder and the diluted phosphoric acid are mixed and stirred for 30-60 min, such as 30 min, 35 min, 40 min, 45 min, 50 min, 55 min or 60 min; however, the time is not limited to the listed values, and other unlisted values within the numerical range are also applicable.

Preferably, the drying is performed at 90-110° C., such as 90° C., 92° C., 94° C., 96° C., 98° C., 100° C., 103° C., 104° C., 106° C., 108° C. or 110° C.; however, the temperature is not limited to the listed values, and other unlisted values within the numerical range are also applicable.

Preferably, the drying is performed for 1-1.5 h, such as 1.0 h, 1.1 h, 1.2 h, 1.3 h, 1.4 h or 1.5 h; however, the time is not limited to the listed values, and other unlisted values within the numerical range are also applicable.

The insulation coating process involved in the present application refers to the coating process of metal soft magnetic material, which improves the insulation and corrosion resistance of the surface of the metal soft magnetic powder, including phosphating, acidification, slow oxidation, nitridation and other surface treatments; the insulation of the metal soft magnetic powder is improved mainly by adding a high-resistivity powder material or in-situ growing a high-resistivity coating layer on the surface of the metal soft magnetic particles, including silicon dioxide, aluminum oxide, magnesium oxide, kaolin, zirconium oxide, mica powder and other materials. Different coating methods and coating processes are applied to different metal soft magnetic alloy powder species to achieve the best coating effect.

As a preferred technical solution of the present application, the secondary coating includes: mixing and stirring a coating material and the soft magnetic powder after the insulation coating.

Preferably, the coating material is 2-10 wt % of the soft magnetic powder, such as 2 wt %, 3 wt %, 4 wt %, 5 wt %, 6 wt %, 7 wt %, 8 wt %, 9 wt % or 10 wt %; however, the amount is not limited to the listed values, and other unlisted values within the numerical range are also applicable.

Preferably, the coating material includes a phenolic resin, an epoxy resin or a silicon resin.

Preferably, the coating material and the soft magnetic powder are mixed and stirred for 40-60 min, such as 40 min, 42 min, 44 min, 46 min, 48 min, 50 min, 52 min, 54 min, 56 min, 58 min or 60 min; however, the time is not limited to the listed values, and other unlisted values within the numerical range are also applicable.

As a preferred technical solution of the present application, the pelletizing treatment includes: pelletizing the soft magnetic powder after the secondary coating, and airing, drying and cooling the soft magnetic powder in sequence after the pelletizing to obtain the magnetic powder.

Preferably, the pelletizing is performed in a 40-60 mesh pelletizer, such as 40 mesh, 42 mesh, 44 mesh, 46 mesh, 48 mesh, 50 mesh, 52 mesh, 54 mesh, 56 mesh, 58 mesh or 60 mesh; however, the pelletizer is not limited to the listed values, and other unlisted values within the numerical range are also applicable.

Preferably, the airing is performed for less than or equal to 3 h, such as 0.5 h, 1 h, 1.5 h, 2 h, 2.5 h or 3 h; however, the time is not limited to the listed values, and other unlisted values within the numerical range are also applicable.

Preferably, the soft magnetic powder after the airing is sieved by a 30-50 mesh screen, such as 30 mesh, 32 mesh, 34 mesh, 36 mesh, 38 mesh, 40 mesh, 42 mesh, 44 mesh, 46 mesh, 48 mesh or 50 mesh, and then dried; however, the screen is not limited to the listed values, and other unlisted values within the numerical range are also applicable.

Preferably, the drying is performed at 50-70° C., such as 50° C., 52° C., 54° C., 56° C., 58° C., 60° C., 62° C., 64° C., 66° C., 68° C. or 70° C.; however, the temperature is not limited to the listed values, and other unlisted values within the numerical range are also applicable.

Preferably, the drying is performed for 0.8-1.2 h, such as 0.8 h, 0.9 h, 1.0 h, 1.1 h or 1.2 h; however, the time is not limited to the listed values, and other unlisted values within the numerical range are also applicable.

Preferably, the cooling is natural cooling.

Preferably, the soft magnetic powder after the cooling is sieved by a 30-50 mesh screen, such as 30 mesh, 32 mesh, 34 mesh, 36 mesh, 38 mesh, 40 mesh, 42 mesh, 44 mesh, 46 mesh, 48 mesh or 50 mesh, and then added with an auxiliary material to obtain the magnetic powder; however, the screen is not limited to the listed values, and other unlisted values within the numerical range are also applicable.

Preferably, the auxiliary material includes magnesium oxide, a lubricant powder or a demoulding powder.

In a second aspect, the present application provides a co-fired inductor prepared by the preparation method according to the first aspect, in which the co-fired inductor includes a magnetic core and at least one wire inside the magnetic core, in which two ends of the wire extend out of the magnetic core, and a portion of the wire extending out of the magnetic core is bent and tightly touches an outer wall of the magnetic core.

As a preferred technical solution of the present application, the wire is a bare wire without paint layer.

Preferably, the wire is a copper wire.

Preferably, the wire is a flat wire having a rectangular cross section.

Preferably, the wire is a straight wire or a special-shaped wire.

Preferably, a shape of the special-shaped wire includes an S-shape, an L-shape, a U-shape, a W-shape or an E-shape.

The wire used in the present application has no paint layer, the shape of the wire is an S-shape, an L-shape, a U-shape, a W-shape, an E-shape, etc., the wires are insulated from touching each other, and the short circuit problem between the wires is avoided.

Preferably, the wires are laid inside the magnetic powder side by side at intervals on a horizontal plane.

Preferably, one of the long sides of the rectangular interface between the portion of the wire extending out of the magnetic core and the magnetic core is used as a bend line, and the portion of the wire extending out of the magnetic core is bent along the bend line and then tightly touches the outer wall of the magnetic core.

Preferably, the wire has a width of 2-3 mm, such as 2.0 mm, 2.1 mm, 2.2 mm, 2.3 mm, 2.4 mm, 2.5 mm, 2.6 mm, 2.7 mm, 2.8 mm, 2.9 mm or 3.0 mm; however, the width is not limited to the listed values, and other unlisted values within the numerical range are also applicable.

The wire has a length of 10-20 mm, such as 10 mm, 11 mm, 12 mm, 13 mm, 14 mm, 15 mm, 16 mm, 17 mm, 18 mm, 19 mm or 20 mm; however, the length is not limited to the listed values, and other unlisted values within the numerical range are also applicable.

The wire has a thickness of 0.2-0.4 mm, such as 0.2 mm, 0.22 mm, 0.24 mm, 0.26 mm, 0.28 mm, 0.3 mm, 0.32 mm, 0.34 mm, 0.35 mm, 0.38 mm or 0.4 mm; however, the thickness is not limited to the listed values, and other unlisted values within the numerical range are also applicable.

Preferably, the co-fired inductor is of cuboid morphology.

Preferably, the co-fired inductor has a length of 7-10 mm, such as 7.0 mm, 7.2 mm, 7.4 mm, 7.6 mm, 7.8 mm, 8.0 mm, 8.2 mm, 8.4 mm, 8.6 mm, 8.8 mm or 9.0 mm; however, the length is not limited to the listed values, and other unlisted values within the numerical range are also applicable.

The co-fired inductor has a width of 5-7 mm, such as 5.0 mm, 5.2 mm, 5.4 mm, 5.6 mm, 5.8 mm, 6.0 mm, 6.2 mm, 6.4 mm, 6.6 mm, 6.8 mm or 7.0 mm; however, the width is not limited to the listed values, and other unlisted values within the numerical range are also applicable.

The co-fired inductor has a height of 1.5-3 mm, such as 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm or 3.0 mm; however, the height is not limited to the listed values, and other unlisted values within the numerical range are also applicable.

Compared with the prior art, the present application has the following beneficial effects.

The preparation method provided by the present application adopts an integrated molding process to prepare the inductor, avoiding the assembly processes of too many components; the heat treatment performed after the integrated molding fully releases stress and reduces the hysteresis losses of materials; the device losses are reduced at the underloading operating conditions; no extra gap exists between the wire and the magnetic core, and air gaps are uniformly distributed in the magnetic core, reducing the vibration noise of eddy current losses.

Aiming at the application scenarios of thin type, high current and small inductance at high frequency, the diameter, length and shape of the wire are redesigned in the present application. The flat copper wire with a large cross section directly reduces the DCR of the inductance element. The used wire without paint layer can be subjected to high-temperature heat treatment. The thermal conductivity between the magnetic core and the wire is good, which further reduces the powder core losses, and the design of the power supply with high power density is better satisfied.

Other aspect will become apparent upon reading and understand that detailed description.

### BRIEF DESCRIPTION OF DRAWINGS

FIG. 1 is a structural diagram of a co-fired inductor provided by an embodiment of the present application.

### REFERENCE LIST

1—magnetic core; and 2—wire.

### DETAILED DESCRIPTION

The technical solutions of the present application are further described below with reference to the drawing and embodiments.

### Example 1

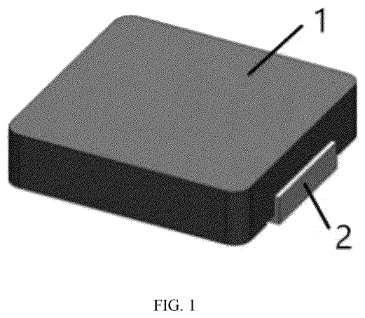

This example provides a preparation method for an integrated co-fired inductor, which includes the following steps:
(1) a mold cavity was filled with a magnetic powder, and a flat copper wire having a rectangular cross section was embedded into the magnetic powder after removing paint layer, in which two ends of the wire 2 extended out of the mold cavity, and the wire 2 was a straight wire 2 which had a length of 14 mm, a width of 2.2 mm, and a thickness of 0.35 mm;
(2) the magnetic powder with the wire 2 embedded was subjected to compression molding in a manner of hot pressing, in which the hot pressing was performed at 500 MPa/cm² and 180° C. for 20 s;
(3) after the molding, an annealing heat treatment was performed under a protective atmosphere to obtain a magnetic core 1, in which the heat treatment was performed at 700° C. for 30 min; and
(4) the wire 2 extending out of the magnetic core 1 was impregnated, spray-coated, bent and tin-attached in sequence to obtain a co-fired inductor with a size of 10.0 mm×5.0 mm×2.0 mm (as shown in FIG. 1), in which the impregnating treatment was vacuum impregnation, and a spray-coating liquid used for the spray-coating was an epoxy resin.

In the method, the magnetic powder in step (1) was prepared by the following method:
(a) powder combination: a FeSi powder with a D50 of 20.2 μm and a carbonyl iron powder with a D50 of 3 μm were mixed according to a mass ratio of 7:3 to obtain a combined soft magnetic powder;
(b) insulation coating: phosphoric acid was diluted with acetone at a mass ratio of phosphoric acid to acetone being 1:60, and the phosphoric acid and acetone were mixed and stirred for 1 min and then stood for 5 min for later use; the combined soft magnetic powder obtained in step (a) was mixed with the diluted phosphoric acid and stirred for 30 min, and dried at 90° C. for 1 h to obtain a phosphated soft magnetic powder;
(c) secondary coating: a coating material was mixed with the soft magnetic powder obtained in step (b) and stirred for 40 min, in which the coating material was 2 wt % of the soft magnetic powder, and the coating material was a phenolic resin; and
(d) pelletizing treatment: the soft magnetic powder after the secondary coating was pelletized in a 40-mesh pelletizer, the soft magnetic powder after the pelletizing was aired for 2 h, and the soft magnetic powder after the airing was sieved by a 30 mesh screen, then dried at 50° C. for 0.8 h, cooled naturally, then sieved by a 30 mesh screen, and then added with an auxiliary material to obtain the magnetic powder, in which the auxiliary material was magnesium oxide.

The prepared co-fired inductor was tested for the inductance characteristics; the initial inductance L(0A) is 120 nH, the saturation current is 70 A, and the temperature rise-current is 65 A. The efficiency test was performed using a 12 V-1 V buck circuit at a switching frequency of 500 kHz; the efficiency reaches 79.5% when the electronic load is 5 A, and the efficiency reaches 88.3% when the electronic load is 15 A.

### Example 2

This example provides a preparation method for an integrated co-fired inductor, which includes the following steps:
(1) a mold cavity was filled with a magnetic powder, and a flat copper wire having a rectangular cross section was embedded into the magnetic powder after removing paint layer, in which two ends of the wire 2 extended out of the mold cavity, and the wire 2 had an S-shape which had a length of 10 mm, a width of 2.6 mm, and a thickness of 0.30 mm;
(2) the magnetic powder with the wire 2 embedded was subjected to compression molding in a manner of hot pressing, in which the hot pressing was performed at 400 MPa/cm² and 175° C. for 25 s;
(3) after the molding, an annealing heat treatment was performed under a protective atmosphere to obtain a magnetic core 1, in which the heat treatment was performed at 650° C. for 50 min; and
(4) the wire 2 extending out of the magnetic core 1 was impregnated, spray-coated, bent and tin-attached in sequence to obtain a co-fired inductor with a size of 8.0 mm×6.0 mm×1.9 mm (as shown in FIG. 1), in which the impregnating treatment was vacuum impregnation, and a spray-coating liquid used for the spray-coating was an epoxy resin.

In the method, the magnetic powder in step (1) was prepared by the following method:
(a) powder combination: a FeSiAl powder with a D50 of 18.3 μm and a FeNi powder with a D50 of 2.8 μm were mixed according to a mass ratio of 75:25 to obtain a combined soft magnetic powder;
(b) insulation coating: phosphoric acid was diluted with acetone at a mass ratio of phosphoric acid to acetone being 1:63, and the phosphoric acid and acetone were mixed and stirred for 3 min and then stood for 6 min for later use; the combined soft magnetic powder obtained in step (a) was mixed with the diluted phosphoric acid and stirred for 40 min, and dried at 95° C. for 1.2 h to obtain a phosphated soft magnetic powder;
(c) secondary coating: a coating material was mixed with the soft magnetic powder obtained in step (b) and stirred for 45 min, in which the coating material was 5 wt % of the soft magnetic powder, and the coating material was an epoxy resin; and
(d) pelletizing treatment: the soft magnetic powder after the secondary coating was pelletized in a 43-mesh pelletizer, the soft magnetic powder after the pelletizing was aired for 2.3 h, and the soft magnetic powder after the airing was sieved by a 35 mesh screen, then dried at 55° C. for 1 h, cooled naturally, then sieved by a 35 mesh screen, and then added with an auxiliary material to obtain the magnetic powder, in which the auxiliary material was a lubricant powder.

The prepared co-fired inductor was tested for the inductance characteristics; the initial inductance L(0A) is 100 nH, the saturation current is 50 A, and the temperature rise-current is 50 A. The efficiency test was performed using a 6 V-0.8 V buck circuit at a switching frequency of 1000 kHz; the efficiency reaches 81.5% when the electronic load is 5 A, and the efficiency reaches 90.3% when the electronic load is 25 A.

### Example 3

This example provides a preparation method for an integrated co-fired inductor, which includes the following steps:
(1) a mold cavity was filled with a magnetic powder, and a flat copper wire having a rectangular cross section was embedded into the magnetic powder after removing paint layer, in which two ends of the wire 2 extended out of the mold cavity, and the wire 2 had a W-shape which had a length of 18 mm, a width of 2.8 mm, and a thickness of 0.26 mm;
(2) the magnetic powder with the wire 2 embedded was subjected to compression molding in a manner of cold pressing, in which the cold pressing was performed at 1600 MPa/cm²;
(3) after the molding, an annealing heat treatment was performed under a protective atmosphere to obtain a magnetic core 1, in which the heat treatment was performed at 690° C. for 40 min; and
(4) the wire 2 extending out of the magnetic core 1 was impregnated, spray-coated, bent and tin-attached in sequence to obtain a co-fired inductor with a size of 7.5 mm×6.5 mm×1.8 mm (as shown in FIG. 1), in which the impregnating treatment was vacuum impregnation, and a spray-coating liquid used for the spray-coating was an epoxy resin.

In the method, the magnetic powder in step (1) was prepared by the following method:
(a) powder combination: a FeNi powder with a D50 of 17.5 μm and a FeSi powder with a D50 of 2.6 μm were mixed according to a mass ratio of 80:20 to obtain a combined soft magnetic powder;
(b) insulation coating: phosphoric acid was diluted with acetone at a mass ratio of phosphoric acid to acetone being 1:65, and the phosphoric acid and acetone were mixed and stirred for 5 min and then stood for 8 min for later use; the combined soft magnetic powder obtained in step (a) was mixed with the diluted phosphoric acid and stirred for 50 min, and dried at 100° C. for 1.3 h to obtain a phosphated soft magnetic powder;
(c) secondary coating: a coating material was mixed with the soft magnetic powder obtained in step (b) and stirred for 55 min, in which the coating material was 7 wt % of the soft magnetic powder, and the coating material was a silicon resin; and
(d) pelletizing treatment: the soft magnetic powder after the secondary coating was pelletized in a 50-mesh pelletizer, the soft magnetic powder after the pelletizing was aired for 2.5 h, and the soft magnetic powder after the airing was sieved by a 40 mesh screen, then dried at 63° C. for 1.1 h, cooled naturally, then sieved by a 40 mesh screen, and then added with an auxiliary material to obtain the magnetic powder, in which the auxiliary material was a demoulding powder.

The prepared co-fired inductor was tested for the inductance characteristics; the initial inductance L(0A) is 150 nH, the saturation current is 80 A, and the temperature rise-current is A. The efficiency test was performed using a 5 V-1 V buck circuit at a switching frequency of 750 kHz; the efficiency reaches 78.2% when the electronic load is 5 A, and the efficiency reaches 92.5% when the electronic load is 45 A.

### Example 4

This example provides a preparation method for an integrated co-fired inductor, which includes the following steps:
(1) a mold cavity was filled with a magnetic powder, and a flat copper wire having a rectangular cross section was embedded into the magnetic powder after removing paint layer, in which two ends of the wire 2 extended out of the mold cavity, and the wire 2 was a straight wire 2 which had a length of 10 mm, a width of 2.0 mm, and a thickness of 0.36 mm;
(2) the magnetic powder with the wire 2 embedded was subjected to compression molding in a manner of cold pressing, in which the cold pressing was performed at 1500 MPa/cm²;
(3) after the molding, an annealing heat treatment was performed under a protective atmosphere to obtain a magnetic core 1, in which the heat treatment was performed at 850° C. for 30 min; and
(4) the wire 2 extending out of the magnetic core 1 was impregnated, spray-coated, bent and tin-attached in sequence to obtain a co-fired inductor with a size of 8.0 mm×5.0 mm×3.0 mm (as shown in FIG. 1), in which the impregnating treatment was vacuum impregnation, and a spray-coating liquid used for the spray-coating was an epoxy resin.

In the method, the magnetic powder in step (1) was prepared by the following method:
(a) powder combination: a FeSiB amorphous powder with a D50 of 23 μm and a carbonyl iron nickel powder with a D50 of 2 μm were mixed according to a mass ratio of 80:20 to obtain a combined soft magnetic powder;
(b) insulation coating: phosphoric acid was diluted with acetone at a mass ratio of phosphoric acid to acetone being 1:70, and the phosphoric acid and acetone were mixed and stirred for 6 min and then stood for 10 min for later use; the combined soft magnetic powder obtained in step (a) was mixed with the diluted phosphoric acid and stirred for 60 min, and dried at 110° C. for 1.5 h to obtain a phosphated soft magnetic powder;
(c) secondary coating: a coating material was mixed with the soft magnetic powder obtained in step (b) and stirred for 60 min, in which the coating material was 10 wt % of the soft magnetic powder, and the coating material was a silicon resin; and
(d) pelletizing treatment: the soft magnetic powder after the secondary coating was pelletized in a 60-mesh pelletizer, the soft magnetic powder after the pelletizing was aired for 3 h, and the soft magnetic powder after the airing was sieved by a 50 mesh screen, then dried at 70° C. for 1.2 h, cooled naturally, then sieved by a 50 mesh screen, and then added with an auxiliary material to obtain the magnetic powder, in which the auxiliary material was magnesium oxide.

The prepared co-fired inductor was tested for the inductance characteristics; the initial inductance L(0A) is 60 nH, the saturation current is 15 A, and the temperature rise-current is 12 A. The efficiency test was performed using a 5 V-1 V buck circuit at a switching frequency of 1500 kHz; the efficiency reaches 89.5% when the electronic load is 0.5 A, and the efficiency reaches 90.5% when the electronic load is 5 A.

1. A preparation method for an integrated co-fired inductor, comprising:
filling a mold cavity with a magnetic powder, embedding at least one wire into the magnetic powder, wherein two ends of the wire extend out of the mold cavity, then performing compression molding and heat treatment in sequence to obtain a magnetic core, and bending and tin-attaching the wire extending out of the magnetic core to obtain the co-fired inductor.

2. The preparation method according to claim 1, wherein the wire is a bare wire without paint layer.

3. The preparation method according to claim 1, wherein the wire is a copper wire.

4. The preparation method according to claim 1, wherein the wire is a flat wire having a rectangular cross section;
preferably, the wire is a straight wire or a special-shaped wire;
preferably, a shape of the special-shaped wire comprises an S-shape, an L-shape, a U-shape, a W-shape or an E-shape;
preferably, the wires are laid inside the magnetic powder side by side at intervals on a horizontal plane.

5. The preparation method according to claim 1, wherein the compression molding is performed in a manner of hot pressing or non-hot pressing;
preferably, the hot pressing is performed at more than or equal to 800 MPa/cm², further preferably 2000 MPa/cm²;
preferably, the hot pressing is performed at 90-180° C.;
preferably, the hot pressing is performed for 5-100 s;
preferably, the heat treatment is an annealing treatment;
preferably, the heat treatment is performed under a protective atmosphere;
preferably, the protective atmosphere uses nitrogen and/or an inert gas;
preferably, the heat treatment is performed at 650-850° C.;
preferably, the heat treatment is performed for 30-50 min.

6. The preparation method according to claim 1, wherein the preparation method further comprises: impregnating and spray-coating the magnetic core in sequence before the bending and tin-attaching;
preferably, the impregnating is vacuum impregnation;
preferably, a spray-coating liquid used for the spray-coating comprises an epoxy resin, a paint or Parylene.

7. The preparation method according to claim 1, wherein the magnetic powder is prepared by the following method: subjecting a soft magnetic powder to insulation coating, secondary coating and pelletizing treatment in sequence to obtain the magnetic powder;
preferably, the soft magnetic powder is obtained by combining powders with two different particle sizes, wherein the powder with a larger particle size has a D50 of 6-50 μm, and the powder with a smaller particle size has a D50 of 1-6 μm;
preferably, the powder comprises FeSiCr, FeSi, FeNi, FeSiAl, a carbonyl iron powder, a carbonyl iron nickel powder, FeNiMo, a Fe-based amorphous nanocrystalline material, a Co-based amorphous nanocrystalline soft magnetic material or a Ni-based amorphous nanocrystalline soft magnetic material.

8. The preparation method according to claim 7, wherein a coating process used for the insulation coating comprises phosphating, acidification, oxidation or nitridation, and further preferably, the soft magnetic powder is subjected to insulation coating by phosphating;
preferably, the phosphating comprises: mixing and stirring the soft magnetic powder and a diluted phosphoric acid, and performing drying to obtain a phosphated soft magnetic powder;
preferably, that phosphoric acid is dilute with acetone;
preferably, the phosphoric acid and acetone have a mass ratio of 1:(60-70);
preferably, the phosphoric acid and acetone are mixed and stirred for 1-6 min, and then stand for 5-10 min for later use;
preferably, the soft magnetic powder and the diluted phosphoric acid are mixed and stirred for 30-60 min;
preferably, the drying is performed at 90-110° C.;
preferably, the drying is performed for 1-1.5 h.

9. The preparation method according to claim 7, wherein the secondary coating comprises: mixing and stirring a coating material and the soft magnetic powder after the insulation coating;
preferably, the coating material is 2-10 wt % of the soft magnetic powder;
preferably, the coating material comprises a phenolic resin, an epoxy resin or a silicon resin;
preferably, the coating material and the soft magnetic powder are mixed and stirred for 40-60 min.

10. The preparation method according to claim 7, wherein the pelletizing treatment comprises:
pelletizing the soft magnetic powder after the secondary coating, and airing, drying and cooling the soft magnetic powder in sequence after the pelletizing to obtain the magnetic powder;
preferably, the pelletizing is performed in a 40-60 mesh pelletizer;
preferably, the airing is performed for less than or equal to 3 h;
preferably, the soft magnetic powder after the airing is sieved by a 30-50 mesh screen, and then dried;
preferably, the drying is performed at 50-70° C.;
preferably, the drying is performed for 0.8-1.2 h;
preferably, the cooling is natural cooling;
preferably, the soft magnetic powder after the cooling is sieved by a 30-50 mesh screen, and then added with an auxiliary material to obtain the magnetic powder;
preferably, the auxiliary material comprises magnesium oxide, a lubricant powder or a demoulding powder.

11. A co-fired inductor prepared by the preparation method according to claim 1, comprising a magnetic core and at least one wire inside the magnetic core, wherein two ends of the wire extend out of the magnetic core, and a portion of the wire extending out of the magnetic core is bent and tightly touches an outer wall of the magnetic core.

12. The co-fired inductor according to claim 11, wherein the wire is a bare wire without paint layer;
preferably, the wire is a copper wire;
preferably, the wire is a flat wire having a rectangular cross section;
preferably, the wire is a straight wire or a special-shaped wire;
preferably, a shape of the special-shaped wire comprises an S-shape, an L-shape, a U-shape, a W-shape or an E-shape;
preferably, the wires are laid inside the magnetic powder side by side at intervals on a horizontal plane.
